(19) United States
(12) Patent Application Publication
(10) Pub. No.: US 2005/0147225 A1
(43) Pub. Date: Jul. 7, 2005

(54) Method of managing prepaid accounts

(76) Inventors: John Christopher Mallick, Dallas, TX (US); Joel Hall, Venice, CA (US); Clay Andrews, Marina del Rey, CA (US); Esther Martinez, Santa Monica, CA (US); Tony Keith, Playa del Rey, CA (US)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 11/029,829

(22) Filed: Jan. 4, 2005

Related U.S. Application Data
(60) Provisional application No. 60/534,676, filed on Jan. 6, 2004.

(51) Int. Cl. H04M 15/00

(52) U.S. Cl. 379/114.2; 379/114.19

(57) ABSTRACT

A method for managing prepaid accounts. A prepaid account is established for an account holder who deposits funds into the account. A virtual account number is issued for the prepaid account. The virtual account number is compatible with a standardized credit transaction system. Use of the virtual account number is limited to transactions placed over the Internet and to transactions between the prepaid account and another prepaid account. A physical credit card for the prepaid account may also be issued to the account holder. Such a credit card has a card account number which is different than the virtual account number. The card account number is also compatible with the standardized credit transaction system. The card account number may also include use limitations.

### PRIORITY

Priority is claimed to U.S. provisional application Ser. No. 60/534,676, filed Jan. 6, 2004. The disclosure of this priority document is incorporated herein by reference.

### BACKGROUND OF THE INVENTION

1. Field of the Invention

The field of the present invention is financial services, more particularly financial services relating to pre-paid credit accounts and methods of managing such accounts.

2. Background

Different types of prepaid credit accounts currently exist in the financial services marketplace. In the traditional form of the pre-paid account, funds are paid into the account, the company managing the account issues a credit card, and the account holder thereafter uses the credit card to access the funds paid into the account. While such accounts offer the convenience of accessing the funds on deposit through a credit card, they offer little in the way of options which provide the account holder with flexibility in determining how the funds on deposit will be withdrawn from the account.

Another type of prepaid credit account is in the form of common bank accounts which have combination credit and debit card associated therewith. Such accounts generally offer a wide variety of options to depositors for determining how the funds on deposit will be withdrawn from the account. The downside of the wide range of flexibility, however, is, that the entire amount of the funds on deposit, which for the average person or business typically represents a significant portion of available liquid assets, is exposed to risk of loss due to fraud.

### SUMMARY OF THE INVENTION

The present invention is directed toward a method of managing prepaid accounts. Initially, a prepaid account is established for an account holder, and funds received from the account holder are placed in the prepaid account. A virtual account number is issued to the account holder. This virtual account number is compatible with standardized credit transaction systems. Use limitations are placed on the virtual account number. The use limitations may include limiting the virtual account number to transactions that are placed over the Internet or to transactions between the prepaid account and another prepaid account.

In a first separate aspect of the present invention, a credit card may be issued to the prepaid account holder. The credit card bears a card account number which is different than the virtual account number. The card account number is also compatible with standardized credit transaction systems. The credit card may also function as a debit card. Further, the card account number may be limited to predetermined transaction types and is preferably not authorized for transactions placed over the Internet.

In a second separate aspect of the present invention, the account holder may submit a transaction request from a remote access point. Such a request may be to transfer funds to a third party for the purchase of goods or services, it may be to transfer funds from one prepaid account to another prepaid account, or it may be to place additional funds into the prepaid account by transferring those funds from a separate monetary account, which is not necessarily another prepaid account, held by the account holder. The remote access point may be any device which is enabled to communicate using the Short Message Service (SMS) standard. A cell phone is one example of such a device.

In a third separate aspect of the invention, one or more prepaid sub-accounts may be created under the first prepaid account, which acts as an umbrella account for each of the prepaid sub-accounts. Funds received from the account holder are placed into one or more of the prepaid sub-accounts. The funds may be transferred directly from an outside account into the prepaid sub-accounts, or they may be transferred from the first prepaid account into the prepaid sub-accounts. A unique virtual account number is issued for each prepaid sub-account. Each of these virtual account numbers is also compatible with the standardized credit transaction system. The account holder may choose to transfer control of any of the prepaid sub-accounts to a third party. After transferring control, the account holder retains authorization to place additional funds into the transferred prepaid sub-account. A credit card may also be issued for each of the prepaid sub-accounts. Each such credit card issued has a card account number which is different than each of the virtual account numbers.

In a fourth separate aspect of the present invention, any of the foregoing aspects may be employed in combination.

Accordingly, the present invention provides an improved method of managing prepaid accounts. Other objects and advantages will appear hereinafter.

### BRIEF DESCRIPTION OF THE DRAWINGS

In the drawings, wherein like reference numerals refer to similar components:

FIG. 1 schematically illustrates a prepaid account system incorporated into a broader transactional structure;

FIG. 2A schematically illustrates a prepaid account when initially established;

FIG. 2B schematically illustrates a prepaid account in which a physical access card has been activated; and

FIG. 2C schematically illustrates a corporate prepaid account.

### DETAILED DESCRIPTION OF THE PREFERRED EMBODIMENTS

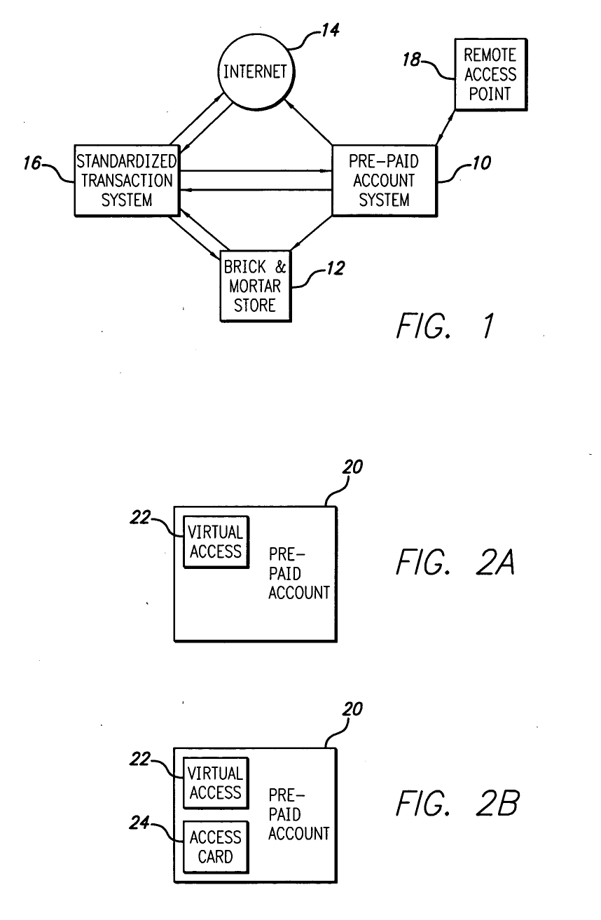

Turning in detail to the drawings, FIG. 1 illustrates a prepaid account system 10 integrated into a financial transactional system. The financial transactional system includes merchants that are of the traditional brick and mortar type 12 and those who are located on the Internet 14. Of course, merchants may also have a presence in both of these realms. Credit card transactions between the merchants and consumers is facilitated by a standardized credit transaction system 16. One such standardized system is operated and maintained by Visa International Service Association, headquartered in San Francisco, Calif. Another such standardized system is operated and maintained by MasterCard International, Incorporated, having offices in Purchase, N.Y. Both of these standardized credit transaction systems are widely used, and integration of a prepaid account system therewith is within the ability of one skilled in the art. The merchants, whether brick-and-mortar or Internet based, the standardized credit transaction system, and the prepaid account system all communicate with each other, as necessary, during the course completing a transaction.

The prepaid account system 10 communicates with one or more remote access points for account maintenance by an account holder. Remote access is initiated by the account holder from a remote access point 18 which may be a single computer with network access, an Internet connected computer, or as explained further below, a Short Message Service (SMS) enabled device.

A prepaid account 20 is established within the prepaid account system by a third party supplying account holder information which includes at least a personal or business name, an address for mailing accounting reports, an email address, and a telephone number. Further, the third party also must supply funds with which to establish the prepaid account. These funds may be supplied in any appropriate format, including cash, a check, a wire transfer, or transfer from another existing credit or debit account. Upon receiving the funds, a virtual account number 22 is issued along with other security information that is appropriate for the particular standardized credit transaction system being used with the prepaid account system. Preferably, the new account holder also provides record of a credit, debit, or other source of funds for replenishing the prepaid account on demand of the account holder. Upon establishing a prepaid account, the new account holder is asked to choose an account name and password for accessing the account over the Internet. Internet access to the account allows the account holder to add additional funds to the account and activate selected options as desired.

Preferably, where the account is established via an Internet transaction with the new account holder, the virtual account number is immediately issued and activated for use through the standardized credit transaction system. When the account is activated for a system such as the Visa® system, an expiration date and a card verification value (CVV2) are also issued. Furthermore, the virtual account number is activated and preferably authorized only for use on the Internet and for transactions with another prepaid account. Preferably, the virtual account number is blocked from usage in point of sale (POS) transactions and Mail Order/Telephone Order (MOTO) transactions.

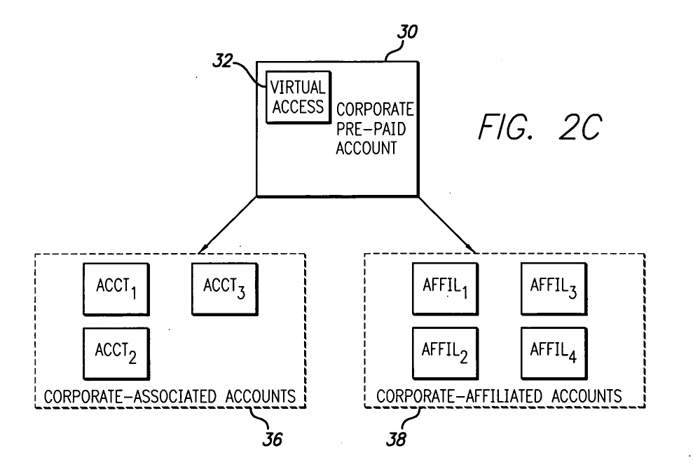

Once the account is established, various account options may be selectively activated. One such account option is illustrated in FIG. 2B. With this option, the account holder may request issuance of a physical card 24. The physical card 24 is issued with its own unique card account number, which is different from the virtual account number 22, and is linked to the previously established prepaid account 20. The account holder may further elect the type of functionality associated with this physical card. For example, the physical card may have the functionality of a standard credit card, a standard debit card or a combination the two types of cards. The physical card is authorized for use in brick and mortar stores; it is preferably not authorized for use in transactions over the Internet or in MOTO transactions.

Where the account holder elects to have the physical card include debit card features, the account holder is also asked to select a Personal Identification Number (PIN) to activate the physical card upon receipt. Selection of the PIN may be done electronically via the Internet by accessing the account using the chosen user name and password. The physical card helps limit the account holder's exposure to fraud. If the card is lost or stolen, the account holder's maximum loss is the balance being maintained in the prepaid account. Further, the ability to replenish the funds in the prepaid account at any time by accessing the account over the Internet, combined with replenishment occurring in real time or nearly in real time, the account holder need not maintain a large balance in the prepaid account. Thus the overall risk of loss is lessened.

Where the physical card only includes the functionality of a debit card, the account holder also benefits from anonymity during transactions because most merchants do not require identification to complete debit transactions. Finally, with debit card functionality, the physical card may be used to withdraw cash from nearly any ATM that subscribes to the standardized credit transaction system.

The functionality of the prepaid account heretofore described has utilized the preexisting standardized credit transaction system 16 to increase the options available to account holders. Functionality may also be added to the prepaid account that does not utilize the preexisting transaction system. The prepaid account system may enable fund transfers between two accounts through use of the virtual account numbers. An account holder may enter the user name and password associated with an account to initiate such a transfer. Once access is gained to the prepaid account system, the account holder indicates the account to which the funds are to be transferred and the amount to be transferred. The account holder of the recipient account is notified of the transfer request and has an opportunity to either accept or reject the transaction. If the transaction is accepted, the funds are deducted from the account of the initiating account holder and added to the account of the receiving account holder. Transactions like the one just described may occur between any two account holders, whether both accounts are personal, one account is a personal or family account and the other is a merchant or business account, or both are merchant or business accounts. One advantage of such transfers is that they do not utilize any standardized credit transaction system and thus do not incur any additional fees that are typically charged when such systems are used.

Transfers may also be initiated with access to the prepaid account system through Short Message Service (SMS) technology and a SMS enabled cell phone. To enable the SMS functionality, the account holder registers the telephone number of an SMS enabled cell phone with the prepaid account system to associate the telephone number with the account holder's account. In addition, the account holder also selects an SMS PIN. The account holder is provided with a central SMS telephone number that is associated with the prepaid account system and set up to receive SMS messages from account holders. An account holder may use the SMS functionality to obtain an account balance, transfer funds between accounts, and replenish the funds in the prepaid account. A short phrase of between one to several letters is associated with each type of transaction. Following the short phrase, the account holder provides the account number associated with the SMS enabled cell phone and additional information which may be required, depending on the type of transaction. For example, a balance request might be formed as follows: “B (account number) (PIN)”. By way of another example a transfer request might be formed as follows: “T (initiating account number) (PIN) (receiving account number)”. Upon receiving an SMS transaction request, the prepaid account system sends a SMS reply to the telephone number on record as being associated with the account that is subject to the request. By responding to the telephone number on record, the chances of processing a fraudulent transaction are reduced because the account holder will be alerted to the attempted fraud via the SMS reply.

Turning to FIG. 2C, a corporate prepaid account is schematically illustrated along with corporate-associated accounts and corporate-affiliated accounts. Such accounts may also be used for any type of group, such as families or volunteer organizations. In addition to the previously discussed options, corporate prepaid accounts are given the option to establish associated and/or affiliated accounts. Both types of accounts, associated and affiliated, have the same type of functionality as all standard accounts. Corporate-associated accounts are established at the request of the account holder of a corporate prepaid account, and the corporate account holder maintains all control over the associated account, including the ability to obtain full reports on account usage. The benefit of a corporate-associated account is that the corporate account holder may establish the associated account and, issue the virtual account number, and a physical card if such is requested, associated therewith to an employee for use as an expense account. The corporate account holder maintains all password protected access to the associated accounts and receives all accounting reports associated with the account.

When a corporation sets up a corporate-affiliated account, control of the account, i.e., all password related access to the account and the ability to obtain reports on account usage, is passed to the affiliate for whom the account was established. The corporation relinquishes almost all control over the affiliated accounts. However, the corporation does retain the ability to deposit funds directly into the prepaid account.

Additional risk management and security features may be implemented within the prepaid account system to limit the risk exposure of an account holder. One such feature is advanced authentication of fund deposit and payment transactions. Both Visa and MasterCard offer such authentication services. Additional authentication may be performed by checking the card verification value (CW2) or the card validation code (CVC2), through an address verification system (AVS), by verifying other transaction-related or personal information of the account holder at the time of a transaction request, by using geo-location software and Internet Protocol (IP) tracing, by using transaction analysis software, by using fraud management software, which typically filters and analyzes all transactions prior to authorization, or by verifying that the merchant category code of the merchant processing the transaction is not on a list of selectively blocked category codes, such lists being set up to prevent risky account or card usage.

Thus, a prepaid account system and a method of managing prepaid accounts are disclosed. While embodiments of this invention have been shown and described, it will be apparent to those skilled in the art that many more modifications are possible without departing from the inventive concepts herein. The invention, therefore, is not to be restricted except in the spirit of the following claims.

1. A method of managing prepaid accounts, the method comprising:
establishing a first prepaid account for a first account holder;
placing funds received from the first account holder into the first prepaid account; and
issuing a first virtual account number, the first virtual account number being compatible with a standardized credit transaction system and being limited to use in transactions placed over the Internet and in transactions between the first prepaid account and a second prepaid account.

2. The method of claim 1 further comprising issuing a credit card to the first account holder, the credit card having a card account number which is different than the first virtual account number and which is compatible with the standardized credit transaction system.

3. The method of claim 2, wherein the credit card also functions as a debit card.

4. The method of claim 2, wherein the card account number is limited to predetermined transaction types.

5. The method of claim 4, wherein the card account number is not authorized for use in transactions placed over the Internet.

6. The method of claim 1 further comprising accepting a transaction request from the first account holder, the transaction request being submitted from a remote access point.

7. The method of claim 6, wherein the transaction request is a request to transfer funds between the first prepaid account and the second prepaid account.

8. The method of claim 6, wherein the transaction request is a request to place additional funds into the first prepaid account.

9. The method of claim 6, wherein the remote access point comprises a Short Message Service (SMS) enabled device.

10. The method of claim 9, wherein the SMS enabled device comprises a cell phone having a phone number associated therewith.

11. The method of claim 10, further comprising:
maintaining record of the phone number associated with the cell phone; and
directing a confirmation of a remote transaction request to the phone number on record.

12. The method of claim 1 further comprising:
creating one or more prepaid sub-accounts under the first prepaid account;
placing funds received from the first account holder into one or more of the prepaid sub-accounts; and
issuing a unique virtual account number for each prepaid sub-account, wherein each unique virtual account number is compatible with a standardized credit transaction system.

13. The method of claim 12 further comprising transferring control of one of the prepaid sub-accounts from the first account holder to a third party, wherein the first account holder retains authorization to place additional funds into the prepaid sub-accounts.

14. The method of claim 12 further comprising issuing a credit card for each prepaid sub-account, wherein the credit card has a card account number which is different than the virtual account number for each prepaid sub-account.

15. The method of claim 1 further comprising establishing the second prepaid account for a second account holder.

16. A method of managing prepaid accounts, the method comprising:
establishing a first prepaid account for a first account holder;
placing funds received from the first account holder into the first prepaid account;
issuing a first virtual account number, the first virtual account number being compatible with a standardized credit transaction system and being limited to use in transactions placed over the Internet and in transactions between the first prepaid account and a second prepaid account;
issuing a credit card to the first account holder, the credit card having a card account number which is different than the first virtual account number and which is compatible with the standardized credit transaction system; and
accepting a transaction request from the first account holder, the transaction request being submitted from a remote access point.

17. The method of claim 16, wherein the credit card also functions as a debit card.

18. The method of claim 16, wherein the card account number is limited to predetermined transaction types.

19. The method of claim 18, wherein the card account number is not authorized for use in transactions placed over the Internet.

20. The method of claim 16, wherein the transaction request is a request to transfer funds between the first prepaid account and the second prepaid account.

21. The method of claim 16, wherein the transaction request is a request to place additional funds into the first prepaid account.

22. The method of claim 16, wherein the remote access point comprises a Short Message Service (SMS) enabled device.

23. The method of claim 22, wherein the SMS enabled device comprises a cell phone having a phone number associated therewith.

24. The method of claim 23, further comprising:
maintaining record of the phone number associated with the cell phone; and
directing a confirmation of a remote transaction request to the phone number on record.

25. A method of managing prepaid accounts, the method comprising:
establishing a first prepaid account for a first account holder;
placing funds received from the first account holder into the first prepaid account;
issuing a first virtual account number, the first virtual account number being compatible with a standardized credit transaction system and being limited to use in transactions placed over the Internet and in transactions between the first prepaid account and a second prepaid account;
creating one or more prepaid sub-accounts under the first prepaid account;
placing funds received from the first account holder into one or more of the prepaid sub-accounts; issuing a unique virtual account number for each prepaid sub-account, wherein each unique virtual account number is different than the first virtual account number and is compatible with a standardized credit transaction system; and
issuing a credit card for each prepaid sub-account, each credit card having an unique card account number which is different than the first virtual account number and each unique virtual account number, wherein each unique card account number is compatible with the standardized credit transaction system.

26. The method of claim 25, wherein the second prepaid account is one of the prepaid sub-accounts.

27. The method of claim 25, wherein each credit card also functions as a debit card.

28. The method of claim 25, wherein each unique card account number is limited to predetermined transaction types.

29. The method of claim 27, wherein each unique card account number is not authorized for use in transactions placed over the Internet.

30. The method of claim 25 further comprising transferring control of one of the prepaid sub-accounts from the first account holder to a third party, wherein the first account holder retains authorization to place additional funds into the prepaid sub-accounts.
